(19) United States
(12) Patent Application Publication
(10) Pub. No.: US 2009/0144087 A1
(43) Pub. Date: Jun. 4, 2009

(54) Medication identifying and organizing system

(76) Inventors: Michael Anthony Kelsch, Peachtree City, GA (US); Julie Stelljes Kelsch, Peachtree City, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 11/998,214

(22) Filed: Nov. 29, 2007

(51) Int. Cl. G06Q 50/00

(52) U.S. Cl. 705/3

(57) ABSTRACT

A method and a system designed to assist individual patients and/or caretakers in visually identifying and confirming a single medication or a plurality of medications, based on comparison with an actual-size color photograph of each item of medication. After such verification, the said medication may then be arranged or organized in a container for future use, or immediately ingested by the patient or administered by a caregiver. The medication photographs are available for electronic display means and the images are printable by physicians, pharmacists, caregivers, or wholesale drug suppliers by accessing, via the Internet, a preliminary authentication server which electronically records, stores and integrates databases containing the relevant medication and patient information.

### CROSS-REFERENCES TO RELATED APPLICATIONS

U.S. Patent Documents

| | | | |
|---|---|---|---|
| 4,730,849 | March 1988 | Siegel | 283/70 |
| 4,732,411 | March 1988 | Siegel | 283/75 |
| 5,031,937 | July 1991 | Nelhaus | 283/52.1 |
| 5,393,100 | March 1995 | Coe | 283/115 |
| 5,758,096 | May 1998 | Barsky, et. al. | 705/3 |
| 6,421,650 | July 2002 | Goetz, et. al. | 705/3 |
| 6,543,616 B1 | April 2003 | Peterson | 206/534 |

Foreign Patent Documents

Not applicable.

Other References

Enhancing Prescription Medicine Adherence: A National Action Plan; National Council on Patient Information and Education, 4915 Saint Elmo Avenue, Suite 505, Bethesda, Md. 20814-6082; August, 2007.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

This inventive concept concerns a method of assisting a patient or his/her caregiver in identifying, sorting, and administering particulate medication with confidence and accuracy. Such a system is necessary in consideration of the fact that many patients, particularly senior citizens and the elderly, take on a daily basis, a multiple number of pills. The administration of the pills is often confusing because of the difficult names of certain medications, indistinguishable or unreadable marks on the pills, and various sizes and dosages. Many patients are unable to read the information on the pill bottles or disseminated with the prescription. In one study involving patients over age 60 who were treated at two public hospitals, 81% could not read or understand basic materials, such as prescription labels.

The health status of many Americans has improved substantially, due in great part to the advancements in treatments for serious diseases. Over 300 new drugs, biologics and vaccines have been approved by the U.S. Food and Drug Administration since 1993 to prevent and/or treat over 150 medical conditions. However, a persistent challenge to the health of Americans is improving patient “compliance” (or “adherence”) with their medication regimen. Of particular significance is the rate of non-compliance of people aged 65 and over, who tend to have more long-term, chronic illnesses—such as arthritis, diabetes, high blood pressure, and heart disease. Studies indicate between 40% to 70% of people in this age group do not take their medications at the right time or in the correct amount. Some factors affecting this statistic include patients needing multiple medications, being seen by multiple prescribers, and patients having physical and cognitive challenges.

The Office of the U.S. Surgeon General estimates that more than 45 percent of the adult population have literacy skills at or below the eighth grade reading level, making it difficult for these individuals to read health information, understand basic medical instructions, and adhere to medication regimens. It is also estimated that more than 90 million Americans cannot understand basic instructions on medication labels. According to a 2001 survey of older Americans conducted by the American Society of Health-System Pharmacists (ASHP), 54% take three or four prescription medicines daily and as many as 33% take eight or more medications to treat their health conditions.

Among the strategies health care professionals can adopt to improve patient adherence to their medication schedules is the utilization of medication packaging that helps patients chart and remember to take each dose and providing tools such as medication organizers and reminder charts. Pharmacies can initiate adherence-messaging programs to reach patients using letters, newsletters, brochures, telephone calls, e-mails, faxes, and even pagers. Most of these programs can function through automated pharmacy dispensing records, based on estimates of when the patient may run out of a prescribed medication. These are some of the recommendations put forth in August 2007 by the National Council on Patient Information and Education (NCPIE).

Commitment to a medication regimen has also been shown, by the World Health Organization, to decline between visits to the physician/clinic. This emphasizes why regular interaction between patients and health providers is so important for improving medication use. The present invention is intended to contribute toward helping patients remain aware of their medication regimen and to provide methods by which health care professionals can more regularly communicate with patients and more readily contribute to improving their adherence to the prescriptions.

### Description of the Related Art

U.S. Pat. No. 4,730,849 involves a method of ensuring, in a medical facility, that the proper patient is being administered medication. The invention involves taking a photograph of the medication and affixing it to a label which is then placed on the container of the medication.

U.S. Pat. No. 4,732,411 also is concerned with a very similar method as the previous patent. This method involves the utilization a photograph and a description of the medication and dosage to be applied to the label of any means used to transport the medication to the patient.

U.S. Pat. No. 5,031,937 is a system wherein photographs of prescribed medications are placed on picture stamps. The picture stamps can then be placed on cards, sheets, or formatted charts corresponding to the times of day at which the medications are to be administered.

U.S. Pat. No. 5,393,100 is a method of scheduling medication for a patient by providing stickers, each having an easily identifiable picture of, and instructions regarding the medication thereon. The stickers are appropriately placed on a pad of medicine schedules and/or a pad of medicine display cards as needed.

U.S. Pat. No. 6,421,650 is a medication management system with three components; patient, physician, and pharmacist. At least one of the components of physician or pharmacist enables the user to search a medication database to determine potential medication interactions. The patient database contains patient medical history, prior prescribed medications, and current prescribed medications. The patient component also includes an alarm function to alert the patient to potential interactions between medications.

### BRIEF SUMMARY OF THE INVENTION

The inventive concept is a method of assisting patients and/or caregivers identify medications, based on comparison with an actual-size color photograph of each medication, after which, the said medication may then be arranged or organized in a container for future use, or immediately ingested or administered by a caregiver. This system also is designed to assist health care professionals, particularly physicians and pharmacists, in (1) providing patients with a personal record of photographic images of the particular medications which are currently prescribed for their use and (2) reviewing and analyzing the medical and prescription history of patients. The medication photographs are accessible and printable by physicians, pharmacists, or wholesale pharmaceutical suppliers by accessing, via the Internet, a specific electronic database which is continually updated. The system is further designed so as to comply with Federal regulations applicable to the privacy rights of patients, in particular the disclosure of personal medical information.

### BRIEF DESCRIPTION OF THE DRAWINGS

FIG. 1 presents the basic embodiment of this inventive concept, demonstrating the process operating by virtue of a patient or caregiver submitting a prescription to be filled. The pharmacist, upon completing the prescription, accesses the system website and is able to download digital images of the color photographs of all current medications which the patient should be taking, including the current transaction for the new medication or a refill.

FIG. 2 illustrates the logic associated with the system operation. The “Start” point is indicative of a user logging in and beginning the authentication process. The manner in which the First and Second Databases are accessed is summarized within the boxed-in diagrams.

FIG. 3 presents a flow chart depicting the interrelationship among a multiple number of users and components of this inventive concept, as shown in an expanded embodiment.

### DETAILED DESCRIPTION OF THE EMBODIMENTS

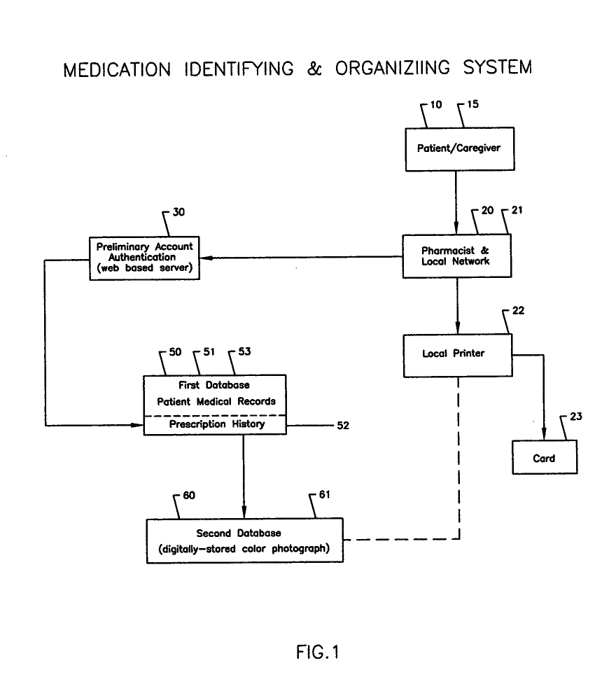

In referring to FIG. 1, the basic embodiment is shown in its most likely business mode. The operation of the method and system is initiated by a patient 10, or the patient's caregiver 15, either of whom presents a new prescription or a prescription for a refill to a pharmacist 20. The prescription has been written by a physician and contains the usual information, including strength, dosage and frequency of ingestion of the medication. The pharmacist 20 inputs information regarding the prescribed medication into the pharmacy's customer prescription files, such files residing on the pharmacy's desktop or laptop computer. In all likelihood, such files are stored and/or accessed through a standardized electronic template or customized software provided by the pharmacy's local network 21.

After accessing his drug inventory to physically retrieve the prescribed medications, the pharmacist 20 inquires of the patient 10 as to whether his or her medical records 51 and/or prescription history 52 are stored in the MIOS system which is accessible on the Preliminary Account Authentication Website 30. The pharmacist 20 may log in to the Preliminary Account Authentication Website through his employer's local network 21, if available. If the patient 10 is not presently registered in the MIOS system, the pharmacist 20 may offer to access the Second Database 60, through his employer's local network 21, in order to acquire a color digital image of the medication(s) presently being prescribed. At this point the pharmacist 20 may make note of any possible adverse effects resulting from any medication(s) the patient 10 is currently taking when combined with the prescription being presently filled.

If the patient is not registered in the system he/she may, at a later date, choose to have his physician 40 access the Preliminary Account Authentication Website 30 and upload the patient's personal medical records 51 and prescription history 52, thus completing a full registration in the system. It should be noted that, in consideration of Federal regulations, the system is designed with a means of blocking access to a patient's medical records 51 if they are stored in the system.

If the patient 10 indeed has an established account in the system, the pharmacist 20 will observe on his computer screen a prompt generated by the system software which asks for entry of the relevant information. The patient 10 should manually enter, on a portable electronic keyboard, his account number, Personal Identification Number (PIN), and the proper password. After correct entry of this information, a template 53 appears which must be completed by the pharmacist 20. The pharmacist 20 must confirm the information on the template 53 which should minimally include name, birth date, address, phone number, designated contact person, doctor's name and phone number, the name of the medication, and the medication's National Drug Code (NDC) and tracking numbers. The pharmacist 20 next activates the Preliminary Account Authentication website 30, which in turn utilizes its internal programming to verify the identity of the patient 10 and the correct medication tracking number or numbers, manufacturer, and dosage.

Once the authenticating process is completed, the Preliminary Account Authentication website 30 then communicates with the First Database 50, containing the patient's medical records 51 and his/her current prescription history 52. This First Database 50 is enhanced with adequate security provisions in compliance with the Health Insurance Portability and Accountability Act (HIPAA). The Privacy Rule of this Act establishes regulations for the use and disclosure of Protected Health Information, which is any information about a patient's health status, provision of health care, or payment for health care that can be linked to an individual. 45 C.F.R. 164.501. Consequently, the system does not allow the pharmacist 20 access to the personal medical records 51 of the patient 10.

The First Database 50, once the patient's information is submitted by the pharmacist 20, interfaces with the Second Database 60 to search for the color photographs corresponding to the patient's 10 prescribed medications. After a browser locates the data, it downloads the corresponding digital images 61 and provides a menu of selectable items, including a “print” prompt, on the computer screen of the pharmacist 20. The pharmacist 20 may select those images of medications that are currently being taken by the patient 10 and send a print command to the printer 22. An appropriately-sized card 23, or glossy photograph paper, containing reproductions of color digital images of all the medications currently prescribed for the patient 10 is then produced.

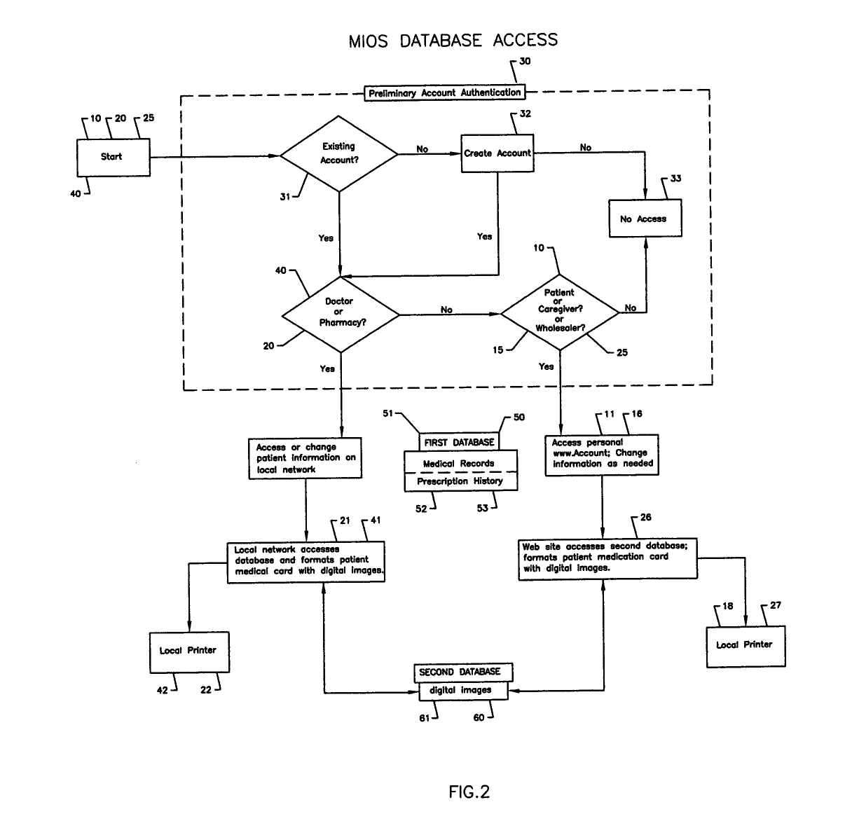

FIG. 2 presents to the viewer a schematic diagram illustrating the human and electronic decision-making steps which occur during operation of the system. It should be noted that the processes shown are applicable to all embodiments of the system in accordance with this inventive concept. The initiation of system operation is depicted at the “Start” block, which represents keying of any computer or other electronic device capable of accessing the World Wide Web by any user, including a patient 10, pharmacist 20, physician 40, or a wholesale drug supplier 25.

Once the Preliminary Account Authentication 30 website is displayed, the user must respond to specific, sequential prompts, such as whether the user has an existing account 31 within the system, or whether the user presently desires to create a new account 32. If the user has no existing account 31, has forgotten his PIN or password, or the account is inactive and the user does not desire to create a new account 32 or reactivate an expired account, then no access 33 to the system is granted to the user.

Once the Preliminary Account Authentication Website 30 has determined that a valid account exists for the user, the template then displays informational windows which must be completed with the required professional information for users such as physicians 40, pharmacists 20, or wholesale drug providers 25. Typical professional information should include at least the user's National Provider Identifier (NPI), Drug Enforcement Agency (DEA) number, state license number, and possibly the user's tax identification number. A licensed health caregiver 15 must also provide the general information applicable to his/her profession. An individual patient 10 need only enter his or her proper PIN and the accompanying password for accessing the system.

After completion of the authentication process, and only if duly authorized by the patient 10, the patient's physician 40 may access the medical records 51 segment of the First Database 50. The system permits a patient's physician 40, or a pharmacist 20 with whom the patient 10 is entering into a transaction for prescription filling. A wholesale drug supplier 25 who has received from the patient 10 a paper or electronic communication for prescription filling, may access the Second Database 60 to download images. The patient 10 and/or caregiver 15 may access the prescription history 52 segment of the First Database 50. Only a physician 40 may delete medications no longer current. Pharmacists may add newly-prescribed medications to the First Database 50 prescription history 51 segment, but only with precise reference to a valid prescription written by a physician 10.

FIG. 2 also shows the Second Database 60 and the continuation of the process of obtaining the photographs of the patient's 10 medications. Physicians 40 and pharmacists 20 who have continuous access to a local network at their place of employment may use this network to select the format 61 upon which the digital images may be downloaded and printed. Physicians may choose to display the medication images on their office computer, a hand-held personal digital assistant (PDA) 46, or any other similar electronic display device now in use or later developed for similar display functions.

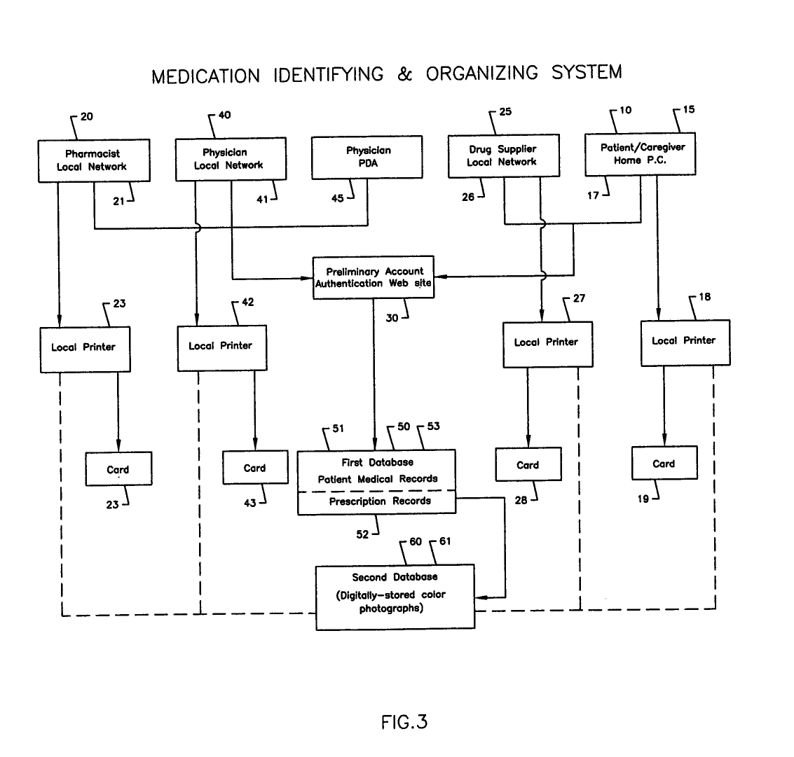

Now, referring to FIG. 3, there is shown an expanded embodiment of this inventive concept. Medical professionals, including pharmacists 20, physicians 40, and wholesale drug suppliers 25 may be subscribers authorized to access the system by payment of an annual registration fee and a nominal charge per each access. It should be noted that only a physician 40 has the credentials necessary to access the secure medical records 51 segment of the system, and only in regard to those patients who are under the physician's care, or who have given their express written consent to the physician 40. Patients 10 need not pay a fee to establish an account; however, they must give explicit consent, in writing, for their physician 40 to upload their medical records onto their system account.

A pharmacist 20 may access the minimally secure prescription history 52 segment of the First Database 50, for two purposes: (1) notating and advising the patient 10 that there may be adverse health effects resulting from ingesting the prescribed medication in combination with the patient's current medications, and/or (2) downloading and printing a color digital image of the prescribed drugs. A wholesale drug distributor 25, after logging in to the Primary Account Authentication website, will be displayed a specially designed software template. Upon entry of the required information into the template, the distributor 25 may directly access the Second Database 60 for the purpose of downloading digital images of the drug or medication(s) corresponding to the prescription(s) or mail order the distributor 25 is filling for the remotely located patient 10.

A patient 10 or caregiver 15 may also access the Second Database 60 to print digital images of the patient's 10 prescribed medications. Caregivers 15, if not a patient of a subscribing physician themselves, may only access the system by virtue of the permission and entrustment to them of the PIN and password of the patient 10 whose health care the caregiver 15 is entrusted.

What is claimed is:

1. a method and a system of enabling electronic access, by a plurality of users, to a digitally stored database of color photographs of specific medications, comprising
(a) providing a Preliminary Account Authentication Website equipped with a computer program to receive an input from a user, identify an account associated with the user, and to authenticate the user for a single subsequent transaction;
(b) providing a First Database with a segment containing information about the personal medical records and a segment containing medication prescription history of a plurality of persons;
(c) a network connection and interface between the Preliminary Account Authentication Website and the First Database;
(d) providing a Second Database containing continually updated, digital images of color photographs of all medications available via over-the-counter purchase, or by prescription from physicians world-wide;
(e) a network connection and interface between the First Database and the Second Database;
(f) providing a computer program with a server capable of browsing the Second Database and sorting out those digital images corresponding to the input entered by the user; and
(g) a plurality of input terminals, computers, hand-held devices, or other electronic devices at any variety of user locations worldwide, such terminals, computers, and devices capable of accessing Internet websites.

2. A method and a system as in claim 1, further comprising
(a) a plurality of users consisting of registered pharmacists utilizing, at their business locations, terminals or computers capable of accessing Internet websites; and
(b) a Preliminary Account Authentication Web site system further comprising a means of verifying the pharmacist's professional credentials, Federal Drug Enforcement Agency (DEA) number, and National Provider Identifier (NPI), and other information, if applicable;
(c) providing a computer program including a server with a capability limited to, after proper authentication, searching the segment of the First Database containing the prescription history of any one of said persons whose information is contained in the First Database;
(d) a First Database, further comprising security access parameters safeguarding access to the segment containing medical records of persons whose information is contained in the First Database;
(e) providing a computer program with a server capable of searching the Second Database and sorting out those digital images of medications corresponding to the input of the pharmacist and/or the existing prescription history of the person; and
(f) a means for downloading and printing, on a suitable format, the digital images of the color photographs of the said medications.

3. A method and a system as in claim 1, further comprising
(a) a plurality of users consisting of duly licensed physicians supplied with
i) terminals or computers at a plurality of business locations, and/or
ii) palm-held digital assistants (PDA's),
any of these devices capable of accessing Internet websites;
(b) a Preliminary Account Authentication Web site further comprising a means of authenticating the physician's professional credentials, Federal Drug Enforcement Agency (DEA) number, and National Provider Identifier (NPI), if applicable;
(c) a First Database, further comprising security access parameters safeguarding access to the segment containing medical records of persons whose information is contained in the First Database;
(d) providing a computer program including a server capable of searching, after proper authentication, the First Database and accessing medical records and prescription history of any person who is a patient of the physician, or any person who has given written authorization to the physician;
(e) a network connection and interface between the Preliminary Account Authentication Website and the Second Database;
(f) a means for downloading and printing, on a suitable format, the digital images of the color photographs of the said medications.

4. A method and a system of enabling electronic access, by a plurality of users, to a digitally stored database of color photographs of specific medications, comprising
(a) a plurality of users consisting of properly licensed wholesale drug distributors and shipping facilities, such distributors and facilities equipped with terminals or computers capable of accessing Internet websites;
(b) a Preliminary Account Authentication Web site further comprising a means of authenticating the Federal Drug Enforcement Agency (DEA) number, and National Provider Identifier (NPI), and tax identification number, if applicable, of the wholesale drug distributors and/or shipping facilities;
(c) providing a database containing continually updated, digital images of color photographs of all medications available via over-the-counter purchase, or by prescription from physicians world-wide;
(d) a network connection and interface between the Preliminary Account Authentication Website and the database;
(e) providing a computer program with a server capable of browsing the database and sorting out those digital images corresponding to the input entered by the user; and
(f) a means for downloading and printing, on a suitable format, the digital images of the color photographs of the said medications of those persons whose prescriptions have been submitted to any of the system users.

5. A method and a system, as in claim 1, further comprising
(a) a plurality of users, said users consisting of patients and/or caregivers with computer access to Internet websites;
(b) providing a Preliminary Account Authentication Website site system equipped with a computer program to receive an input from the patient or caregiver, identify an account associated with the patient, and to authenticate the patient or caregiver for a single subsequent transaction;
(c) providing a First Database with a segment containing personal medical records and a segment containing prescription history of a plurality of persons, and a means of allowing secure access only to the prescription history corresponding to the account, Personal Identification Number (PIN), and password submitted by the patient or caregiver;
(d) a network connection and interface between the Preliminary Account Authentication Website and the First Database;
(e) providing a Second Database containing continually updated, digital images of color photographs of all medications available over-the-counter or by prescription from physicians world-wide;
(f) a network connection and interface between the First Database and the Second Database;
(g) providing a computer program with a server capable of searching the Second Database and sorting out those digital images corresponding to the input entered by the patient or caregiver;
(h) a means for downloading and printing, on a suitable format, the digital images of the indicated medications.

6. A method and a system designed to enable electronic access by a plurality of users, to a digitally stored database containing medical information and prescription history of a plurality of persons, for the purpose of conducting an analysis of any potential adverse effects resulting from a combination of medications being concurrently taken by any of such persons, comprising
(a) a plurality of users consisting of duly licensed physicians and pharmacists supplied with i) terminals or computers, and/or ii) palm-held digital assistants (PDA's), and/or iii) other electronic or infrared devices, any of these devices capable of accessing Internet websites;
(b) a database, consisting of two separate segments, the first segment containing medical information and a second segment containing prescription history of each of the said persons, and said database further comprising security access parameters safeguarding access to the medical records segment;
(c) a Preliminary Account Authentication Internet website further comprising a means of identifying and verifying the physician's or pharmacist's professional credentials, Federal Drug Enforcement Agency (DEA) number, and National Provider Identifier (NPI), if applicable, and authenticating the user for a series of inquiries or inputs regarding the prescription history of any one of the said persons in the database;
(d) a network connection and interface between the Preliminary Account Authentication Website and the database;
(e) providing a computer program including a server capable of searching, after proper authentication, the database and accessing the prescription history of any of said persons who is a patient of a physician user, or any person who has given written authorization to a physician or a pharmacist; and
(f) a means of providing a visual or audible alert to any potentially harmful combination of any of the medications existing in the displayed record of the prescription history of any of said persons.
